(19) United States
(12) Patent Application Publication
(10) Pub. No.: US 2005/0270301 A1
(43) Pub. Date: Dec. 8, 2005

(54) Color control system and color control method for the same

(75) Inventor: Shigeyuki Kitazawa, Kawaguchi-shi (JP)

Correspondence Address: LUCAS & MERCANTI, LLP, 475 PARK AVENUE SOUTH, 15TH FLOOR, NEW YORK, NY, 10016, US

(73) Assignee: Konica Minolta Medical & Graphic, Inc.

(21) Appl. No.: 11/138,174

(22) Filed: May 26, 2005

(30) Foreign Application Priority Data
Jun. 3, 2004 (JP) JP2004-166163

(51) Int. Cl. G09G 5/02

(52) U.S. Cl. 345/590

(57) ABSTRACT

A color control system for controlling display colors of plural display sections arranged at respective sites for displaying color images, including: plural terminal apparatuses, each having; a display section, and a transmitting section for transmitting measured values of display colors of the display section measured by a calorimeter and identification information for discriminating the display section; and a control server connected to the plurality of terminal apparatuses via a network, the control server having; a storing section for storing the transmitted measured values and the identification information by correlating the measured value with the identification information, and an information generating section for forming information readable from the plurality of terminal apparatuses based on the measured values and the identification information such that the display colors of at least two of the plurality of display sections are respectively identifiably superposed for displaying.

This application is based on Japanese Patent Application No. 2004-166163 filed on Jun. 3, 2004 in Japanese Patent Office, the entire content of which is hereby incorporated by reference.

### BACKGROUND OF THE INVENTION

The present invention relates to a color control system and a color control method for controlling display colors of a plurality of display sections for displaying color images which are arranged at each site.

Conventionally, before providing for printing a photographic print document, the reversal film of the photographic print document has been confirmed using a viewer. The viewer used for the confirmation, since the color temperature of the white point of the light source is standardized to 5000 K (Kelvin), ensures the consistency of color visibility.

On the other hand, by the recent spread of digital cameras, feeding of digital data (image data) in place of the reversal film has been generalized. The confirmation of the photographic print document by the digital data is performed by displaying an image based on the digital data on the display section such as a monitor. In this case, since the color visibility depends on the monitor used, there is proposed a technology to perform the color control of the monitor by measuring the chromatic color displayed on the monitor and evaluating the color image display capacity so that the color displayed on the monitor can realize high color reproducibility (for example, refer to Patent Document 1)

Patent Document 1: Japanese Patent Publication Open to Public Inspection No. 2003-241732

However, the color reproduction range of the monitor varies with the method and capacity of each monitor, so that for example, when displaying images of the same digital data on the individual monitors at a plurality of sites and evaluating the colors of those images, the display colors may vary with the difference in the color reproduction range. And, a problem due to the difference in the display color may arise. In such a case, it is desired to confirm and recognize beforehand the color reproduction range of each monitor to be used at each site and the difference in each display color, though there is no means available to confirm the color reproduction range of each monitor at each site and the difference in each display color.

### SUMMARY OF THE INVENTION

The present invention was developed with the foregoing in view and is intended to provide a color control system and a color control method, which can easily confirm differences in display colors of the plurality of display sections arranged at each site for displaying color images.

The aforementioned problems can be solved by the embodiment having the following constitution.

(1) A color control system for controlling display colors of a plurality of display sections arranged at respective sites for displaying color images, the color control system including: a plurality of terminal apparatuses, each of the plurality of terminal apparatuses having; display section of the plurality of display sections, and a transmitting section for transmitting measured values of display colors of the display section measured by a colorimeter, and identification information for discriminating the display section; and

a control server connected to the plurality of terminal apparatuses via a network, the control server having; a storing section for storing the transmitted measured values and the identification information by correlating the measured value with the identification information, and an information generating section for forming information readable from the plurality of terminal apparatuses based on the measured values and the identification information such that the display colors of at least two of the plurality of display sections are respectively identifiably superposed for displaying.

### BRIEF DESCRIPTION OF THE DRAWINGS

FIG. 1 is a functional block diagram showing the system constitution of the color control system relating to the present invention.

FIG. 2 is an external view showing the terminal apparatus having an installed calorimeter.

FIG. 3 is a flow chart showing the measuring and storing procedure of display colors relating to the present invention.

FIG. 4 is a drawing showing an example of the screen displayed on the display section of the terminal apparatus of the color control system.

FIG. 5 is an illustration for explaining measured data and identification information stored in the storing means.

FIG. 6 is a flow chart showing the procedure for supplying display color comparing information relating to the present invention.

FIG. 7 is a drawing showing another example of the screen displayed on the display section of the terminal apparatus of the color control system.

FIG. 8 is a drawing showing an example of display color comparing information prepared by the color control system of the present invention.

FIG. 9 is a drawing showing a color temperature T (K) indicated on an xy chromaticity diagram.

FIG. 10 is a drawing showing numerical values of (x, y) of the color temperature T (K) shown in FIG. 9.

FIG. 11 is a drawing showing still another example of display color comparing information prepared by the color control system relating to the present invention.

FIG. 12 is a drawing showing a further example of display color comparing information prepared by the color control system relating to the present invention.

FIG. 13 is a drawing showing a still further example of display color comparing information prepared by the color control system relating to the present invention.

### DETAILED DESCRIPTION OF THE PREFERRED EMBODIMENT

The aforementioned problems can be further solved by the aspect having the following constitution.

(2) The color control system of Item (1), wherein the information formed by the information generating system is to display the display colors of at least two of the plurality of display sections in a xy chromaticity diagram, a UCS chromaticity diagram, or a a*b* coordinate plane of a L*a*b* color specification system.

(3) The color control system of Item (1), wherein the display colors include a white color, and the information formed by the information generating system is to display the display colors of at least two of the plurality of display sections with a color temperature of a white color point obtained based on the measured values of the white color.

(4) A color control method for controlling display colors of a plurality of display sections arranged at respective sites for displaying color images, the color control method including: the step of measuring the display colors with each of a plurality of terminal apparatuses arranged at each of the sites; the step of transmitting measured values of the display colors of a display section of a plurality of display sections, and identification information for discriminating the display section; and the step of storing the transmitted measured values and the identification information by correlating the measured value with the identification information, with a control server connected to the plurality of terminal apparatuses via a network; and the step of forming information readable from the plurality of terminal apparatuses based on the measured values and the identification information such that the display colors of at least two of the plurality of display sections are respectively identifiably superposed for displaying.

The color control system described in Item (1) transmits the measured values of the display colors of the display section and identification information for discriminating the display section by the plurality of terminal apparatuses arranged at each site, stores the transmitted measured values and identification information by corresponding them to each other by the control server connected via the plurality of terminal apparatuses and the network, and prepares, on the basis of the stored measured values and identification information, readably from the terminal apparatus, information displaying identifiably the display colors of the plurality of display sections respectively, so that differences in display colors of each display section arranged at a distant place.

The color control system described in Item (2) displays the display colors in the xy chromaticity diagram, UCS chromaticity diagram, or a*b* plane of coordinates of the L*a*b* color system, so that the display colors of the respective display sections can be compared easily.

The color control system described in Item (3) displays display colors at a color temperature of the white point, so that the display colors of the respective display sections can be compared easily.

The color control system described in Item (4) transmits the measured values of the display colors of the display section and identification information for discriminating the display section by the plurality of terminal apparatuses arranged at each site, stores the transmitted measured values and identification information by corresponding them to each other by the control server connected via the plurality of terminal apparatuses and the network, and prepares, on the basis of the stored measured values and identification information, readably from the terminal apparatuses, information displaying identifiably the display colors of the plurality of display sections respectively, so that differences in display colors of each display section arranged at a distant place can be easily confirmed.

### Preferred Embodiment

Hereinafter, a preferred embodiment of the color control system and color control method relating to the present invention will be explained in detail with reference to the accompanying drawings.

The color control system of the present invention collects measured values of display colors of a plurality of display sections for displaying color images which are arranged at each site and provides information (hereinafter, referred to as display color comparing information) displaying the display colors of the display section at each site by identifiably superimposing them.

Hereinafter, the constitution of the color control system of this embodiment will be explained in detail by referring to the drawings.

System Constitution

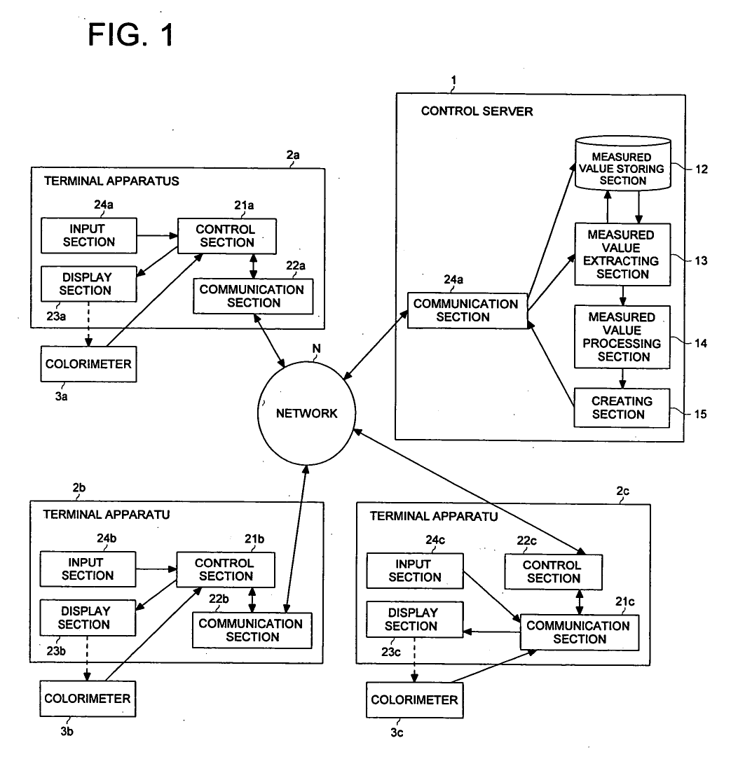

FIG. 1 is a functional block diagram showing the system constitution of the concerned color control system. A control server 1, via a network N such as a leased communication line or Internet, is connected to terminal apparatuses 2 (in the drawing, 2a, 2b, 2c) installed at a plurality of sites at distant places. Furthermore, to each terminal apparatus 2, a calorimeter 3 (in the drawing, 3a, 3b, 3c) is connected as a measuring means for measuring values of color characteristics of display colors of a display section 23, for example, tristimulus values of X, Y, and Z of the XYZ color specification system.

Here, the plurality of sites are, for example, a printing company, an outside supplier of the printing company, and a customer. Further, the terminal apparatuses 2 and the calorimeters 3 are not limited to three units per each shown in FIG. 1 and an optional number may be arranged. Further, output devices not drawn and the calorimeters 3a to 3c may be different from each other in the product and kind.

Each of the terminal apparatuses 2 is the so-called computer terminal and includes an input means 24 (in the drawing, 24a, 24b, 24c) such as a keyboard and a mouse, a display section 23 (in the drawing, 23a, 23b, 23c) which is a monitor such as a CRT (cathode ray tube) and an LCD (liquid crystal display), a communication means 22 (in the drawing, 22a, 22b, 22c) for transmitting and receiving information, and a control means 21 (in the drawing, 21a, 21b, 21c) having a function as a display control means for controlling display of the display section 23 and a web browser function for requiring the control server 1 to transmit screen information via the communication means and the network N, displaying data on the display section 23 on the basis of the screen information received from the control server 1, and transmitting input from the input means to the control server 1. The terminal apparatus 2, using the web browser function, realizes a function as a measured value transmission means for transmitting the measured values such as the tristimulus values of X, Y, and Z of the display colors of the display section 23 for measuring by the colorimeter 3 and the identification information indicating the display section 23 measured to the control server 1 and displays the display color comparing information transmitted from the control server 1 on the display section 2.

The control server 1 is the so-called computer terminal and includes the input means such as the keyboard and mouse, the display section such as the CRT and LCD, and the equipment body such as the server. Further, the control server 1 includes a communication section 11 having a function as a communication means for transmitting and receiving information via the network N and furthermore a measured value storing means 12 having a function as a storing means for storing measured values and identification information transmitted from the terminal apparatuses 2 via the network N and the communication section 11 by relating them to each other. Further, the control server 1 includes a measured value extraction means 13 for extracting measured values of the display section to be compared on the basis of the identification information and a measured value processing means 14 for preparing the display color comparing information on the basis of the extracted measured values. Furthermore, the control server 1 includes a generation means 15 for converting the prepared information to screen information which can be read by the display section of the terminal apparatuses 2. The generated image information is transmitted to the terminal apparatuses 2 via the communication section 11 and the network N. Further, the measured value extraction means 13, the measured value processing means 14, and the generation means 15 constitute the information preparation means of the present invention.

By use of the above constitution, on the basis of a request from each of the terminal apparatuses 2, the display color comparing information of the display colors of the display section of each of the terminal apparatuses 2 can be provided (the procedure thereof will be described later).

Color Control Method

Next, the color control method executed in the color control system will be explained.

Measurement of Display Colors

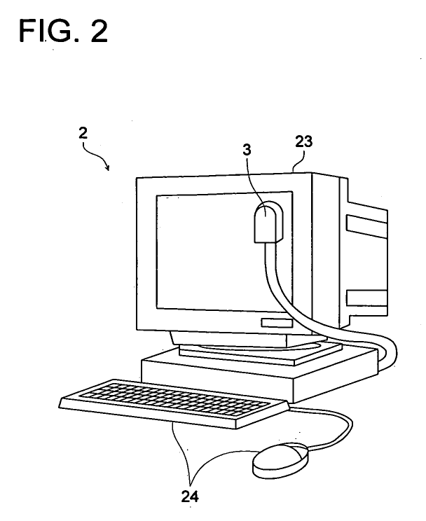

Firstly, the measurement of display colors displayed on the display section 23 will be explained. In FIG. 2, an external view of the terminal apparatus 2 having the calorimeter 3 installed is shown. As shown in FIG. 2, the calorimeter 3 is installed at a predetermined position on the display screen of the display 23 for displaying a color image and is formed so as to measure display colors displayed on the display section 23 and output the measured values. Further, in this embodiment, the measured values are tristimulus values of X, Y, and Z of the XYZ color specification system. Further, the display colors to be measured may be colors used to compare the display colors within the color reproduction range. In this embodiment, a plurality of display colors including at least R (red), G (green), B (blue), and W (white) are used.

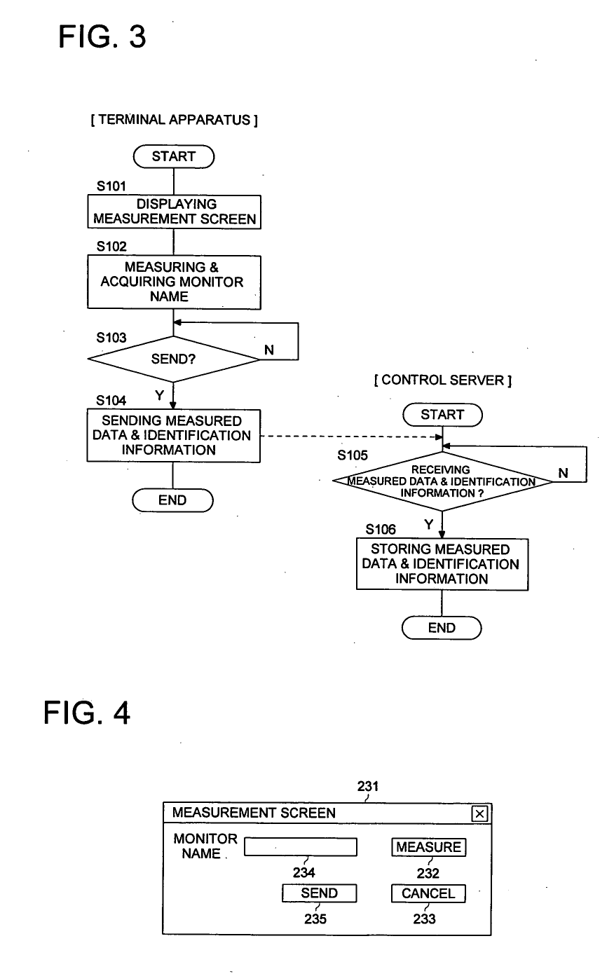

Next, an example of the measuring procedure of display colors will be explained by referring to the drawing. FIG. 3 is a flow chart showing the measuring and storing procedure of display colors.

As shown in FIG. 3, when an operator operates the input means 24 of the terminal apparatus 2, the control means 21 receives the operation contents thereof and displays a measurement screen 231 shown in FIG. 4 on the display section (Step S101, hereinafter, “Step S101” is abbreviated to “S101”, the same may be said with the other steps). And, the display colors are measured, and the monitor name as identification information is input, and the control means 21 obtains the measured values and identification information (S102).

Concretely, when the operator moves the cursor by the mouse or others and clicks a Measurement key 232, the control means 21 sequentially displays the display colors to be measured on the predetermined position on the display screen where the calorimeter 3 is installed or overall the display screen, obtains the measured values of the displayed colors from the calorimeter 3, and measure the display colors. A Cancel key 233 is used to stop the measurement. Next, the operator moves the cursor to a monitor name input field 234 and inputs the monitor name, for example, as “Monitor A” using the keyboard.

When the aforementioned measurement and input are finished and the operator clicks a Send key 235 (Y at S103), the measured values (measured data) and monitor name are transmitted to the control server 1 as identification information and further the transmission date information and transmission source information indicating the site are transmitted to the control server 1 (S104). However, the Send key 235 may be displayed after the measurement and monitor name are inputted. The Cancel key 233 is used to stop the measurement and transmission.

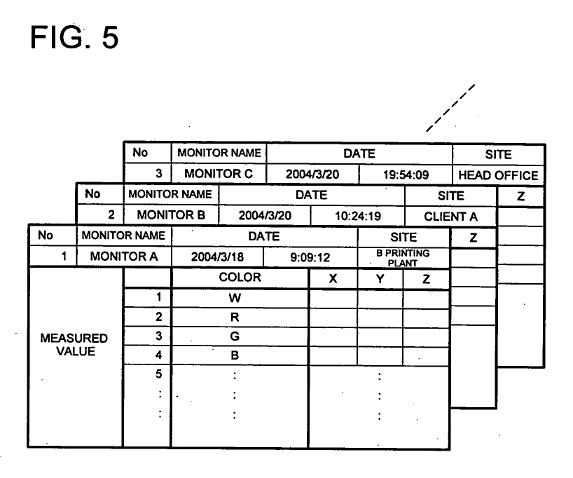

The control server 1, upon receipt of the measured data and monitor name (Y at S105), corresponds the measured data to the monitor name, further corresponds the date and time indicated by the transmission date information to the site indicated by the transmission source information, and stores them in the measured data storing means 12 in a structure as shown in FIG. 5 (S106).

Procedure of Providing the Display Color Comparing Information

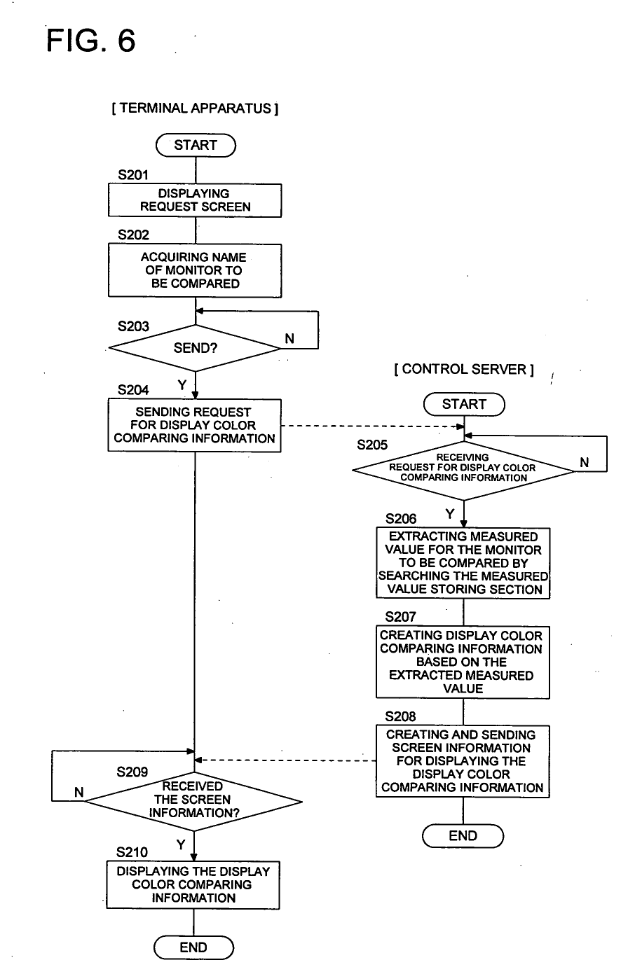

Next, the procedure of providing the display color comparing information will be explained by referring to the flow chart shown in FIG. 6. This embodiment is specialized to provide display color comparing information of at least two display sections connected to the network.

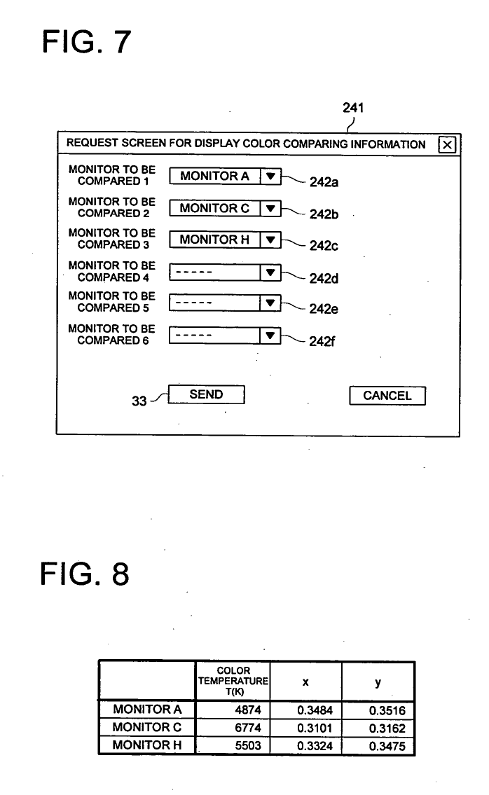

As shown in FIG. 6, when an operator operates the input means 24 of the terminal apparatus 2, the control means 21 receives the operation contents thereof and displays a request screen 241 as shown in FIG. 7 on the display section 23 (S201). Next, the operator, using a plurality of monitor name input fields 242 on the request screen 241, selects two or more monitor names to be compared according to the pull-down menu and the control means 21 obtains the monitor names to be compared (S202). At this time, it is convenient to display the monitor name of the terminal apparatus 2 during operation in one of the monitor name input fields 242. And, when the Send key 243 is clicked (Y at S203), the control means 21 transmits a plurality of monitor names to be compared and also the request for display color comparing information to the control server 1 (S204).

The control server 1 receives the request for display color comparing information (Y at S205) and the measured value extraction means 13 retrieves the measured value storing means 12 and extracts the measured values of a plurality of monitor names transmitted from the terminal apparatus 2 (S206). And, the measured value processing means 14, on the basis of the extracted measured values, prepares display color comparing information (will be described in detail later) for confirming differences in the display colors of the monitors to be compared (S207). Furthermore, the control server 1 generates screen information for making the display color comparing information readable and transmits it to the terminal apparatus 2 (S208).

The terminal apparatus 2 receives the screen information (Y at S209) and displays the display color comparing information on the display section 23 (S210).

In the above explanation, the display color comparing information is transmitted to the terminal apparatus 2 by the image information. However, for example, it may be transmitted by electronic mail and read by the terminal apparatus 2. In this case, the generation means 15 may attach the mail address of the terminal apparatus 2 to be transmitted to the mail including the display color comparing information and transmit the electronic mail by the communication section 11.

Next, an example of the display color comparing information to be prepared will be explained by referring to FIGS. 8 to 13.

FIG. 8 shows an example of a table displaying “Color temperature T (K) of white point” as display color comparing information, in which the chromaticity coordinates (x, y) of each white point obtained from the tristimulus values of X, Y, and Z in the XYZ color specification system which are measured values of W (white) of the monitor A, monitor C, and monitor H arranged at the respective three sites and furthermore the color temperatures T (K) obtained from the chromaticity coordinates (x, y) are shown.

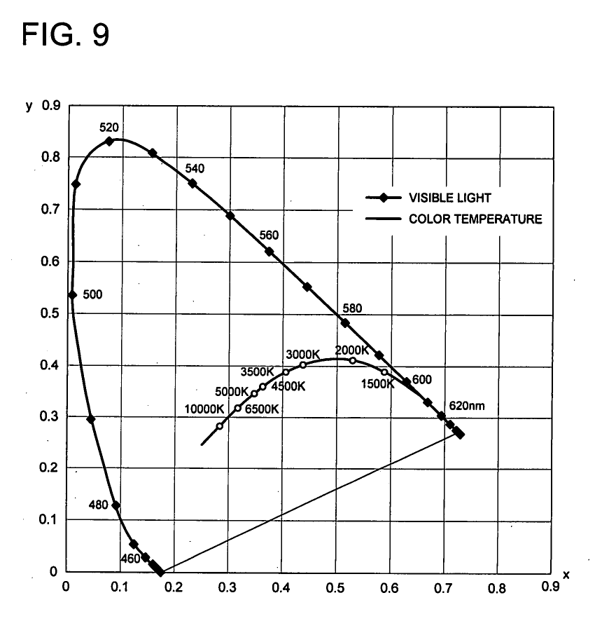

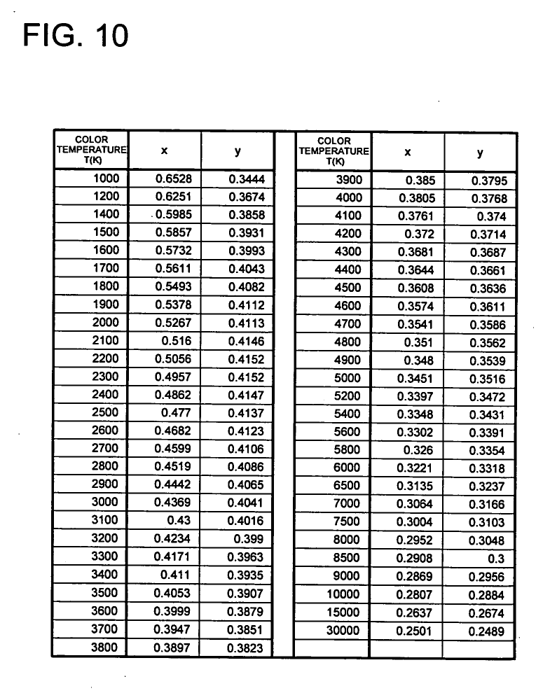

Here, the calculation method of the color temperature of the white point will be explained. Firstly, from the tristimulus values of X, Y, and Z of the measured values of W (white), the chromaticity coordinates (x, y) are obtained as x=X/(X+Y+Z) and y=Y/(X+Y+Z). The color temperature T (K) is shown as a curve as shown in FIG. 9 on the xy chromaticity diagram (in FIG. 9, for reference, the color range of visible light is also shown). Further, FIG. 10 shows the chromaticity coordinates (x, y) of each point of the color temperature shown in FIG. 9 as numerical values and from these numerical values, the approximate points of the chromaticity coordinates (x, y) of W (white) are obtained and furthermore the color temperature can be obtained.

Further, as the color temperature rises from low to high, the color sequentially changes from red to orange, yellow, white, and blue white, so that from comparison of the color temperature of the white point, it can be confirmed that the displayed image is orangish or bluish.

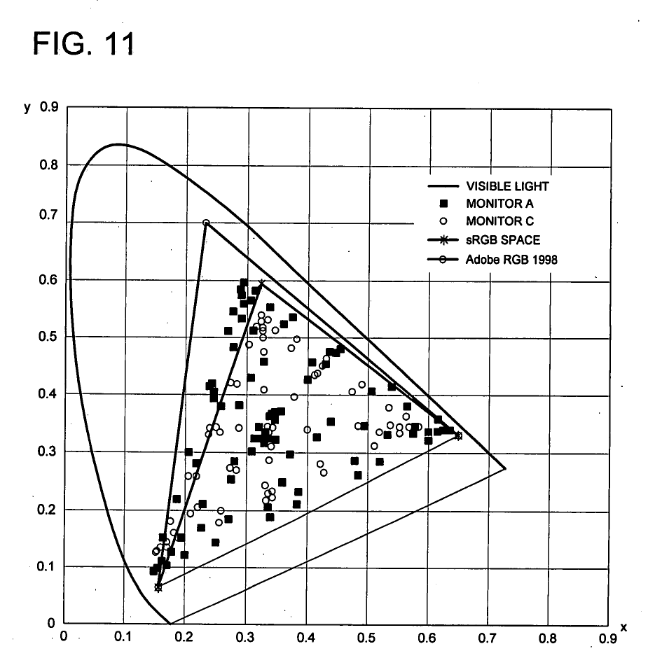

FIG. 11 shows an example of the graph showing “Color reproduction range shown on xy chromaticity diagram” as display color comparing information, and from the measured values of each color of the monitors A and C respectively arranged at two sites, the chromaticity coordinates (x, y) are obtained in the same way as with the aforementioned chromaticity coordinates (x, y) of the white point, and are shown on the xy chromaticity diagram. In FIG. 11, each value of the monitor A is identifiably displayed as ▪, and each value of the monitor C is identifiably displayed as ◯, and for reference, the color range of visible light, the color reproduction range of typical monitor sRGB, and the color 20 7030 reproduction range of typical printing AbobeRGB1998 are shown. In the xy chromaticity diagram which is generally used, for example, from FIG. 11, the color reproduction range of each color and the difference in the color reproduction range can be confirmed.

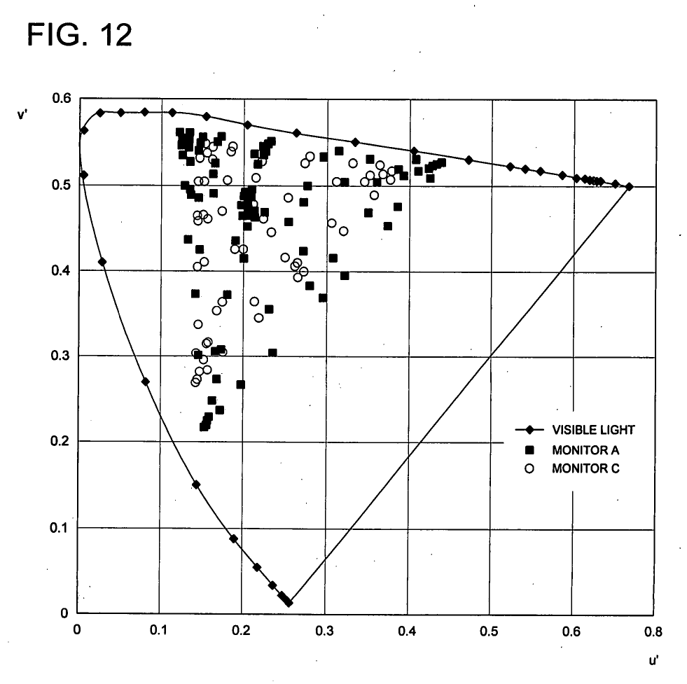

FIG. 12 shows an example of the graph showing “Color reproduction range shown on UCS chromaticity diagram” as display color comparing information and from the measured values of each color of the monitors A and C respectively arranged at two sites, the chromaticity coordinates (u′, v′) are obtained as u′=4X/(X+15Y+3Z)=4x/(−2x+12y+3) and v′=9Y/(X+15Y+3Z)=9y/(−2x+12y+3) and are shown on the UCS chromaticity diagram. In FIG. 12, each value of the monitor A is identifiably displayed as ▪, and each value of the monitor C is identifiably displayed as ◯, and for reference, the color range of visible light is shown. The UCS chromaticity diagram shown in FIG. 12 is a diagram in which the visual difference of color in the xy chromaticity diagram shown in FIG. 11 and the color difference relating to the distance relationship on the xy chromaticity diagram are corrected, thus the difference in the color reproduction range equivalent to the visual difference can be confirmed.

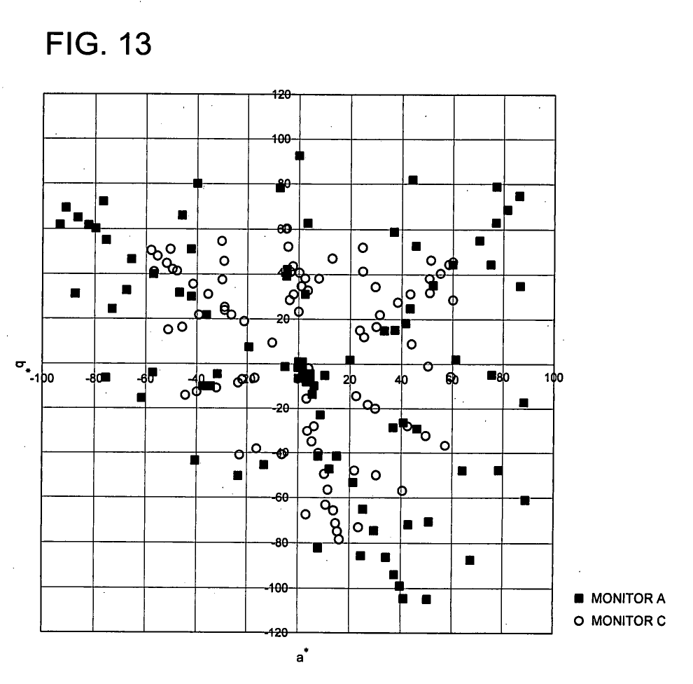

FIG. 13 shows an example of the graph showing “Color reproduction range shown on a*b* plane of coordinates of L*a*b* color specification system” and from the measured values of each color of the monitors A and C respectively arranged at two sites, the chromaticness indexes a* and b* are obtained as indicated below and are shown on the plane of coordinates a*b*. a*=500[(X/Xn)\hat{ }(1/3)−(Y/Yn)\hat{ }(1/3)] (N\hat{ }M indicates power of M of N, the same may be said with the subsequent), and b*=200[(Y/Yn)\hat{ }(1/3)−(Z/Zn)\hat{ }(1/3)], and these values are calculated by the conditions of X/Xn>0.008856, Y/Yn>0.008856, and Z/Zn>0.008856.

Further, when any of X/Xn, Y/Yn, and Z/Zn is 0.008856 or less, in the aforementioned formulas of a* and b*, (X/Xn)\hat{ }(1/3) is replaced with 7.787 (X/Xn)+16/116, and (Y/Yn)\hat{ }(1/3) is replaced with 7.787 (Y/Yn)+16/116, and (Z/Zn)\hat{ }(1/3) is replaced with 7.787 (Z/Zn)+16/116, and they are calculated.

Further, Xn, Yn, and Zn are values varying with the light source and for example, when a D50 light source is used, Xn=96.417, Yn=100, and Zn=82.487.

In FIG. 13, each value of the monitor A is identifiably displayed as ▪, and each value of the monitor C is identifiably displayed as ◯, and the difference in the output color can be confirmed by the difference in the saturation indicated by the distance from the origin of the coordinate axes.

Further, the display color comparing information to be prepared and provided includes one or plural of the aforementioned display color comparing information. Or, although not drawn, it is possible to select the display color comparing information, for example, from the aforementioned examples on the quest screen 241 and generate and provide the selected display color comparing information.

1. A color control system for controlling display colors of a plurality of display sections arranged at respective sites for displaying color images, the color control system comprising:
a plurality of terminal apparatuses, each of the plurality of terminal apparatuses having;
a display section of the plurality of display sections, and
a transmitting section for transmitting measured values of display colors of the display section measured by a calorimeter, and identification information for discriminating the display section; and
a control server connected to the plurality of terminal apparatuses via a network, the control server having;
a storing section for storing the transmitted measured values and the identification information by correlating the measured value with the identification information, and
an information generating section for forming information readable from the plurality of terminal apparatuses based on the measured values and the identification information such that the display colors of at least two of the plurality of display sections are respectively identifiably superposed for displaying.

2. The color control system of claim 1, wherein the information formed by the information generating system is to display the display colors of at least two of the plurality of display sections in a xy chromaticity diagram, a UCS chromaticity diagram, or a a*b* coordinate plane of a L*a*b* color specification system.

3. The color control system of claim 1, wherein the display colors include a white color, and the information formed by the information generating system is to display the display colors of at least two of the plurality of display sections with a color temperature of a white color point obtained based on the measured values of the white color.

4. A color control method for controlling display colors of a plurality of display sections arranged at respective sites for displaying color images, the color control method comprising:
measuring the display colors with each of a plurality of terminal apparatuses arranged at each of the sites;
transmitting measured values of the display colors of a display section of a plurality of display sections, and identification information for discriminating the display section; and
storing the transmitted measured values and the identification information by correlating the measured value with the identification information, with a control server connected to the plurality of terminal apparatuses via a network; and
forming information readable from the plurality of terminal apparatuses based on the measured values and the identification information such that the display colors of at least two of the plurality of display sections are respectively identifiably superposed for displaying.

5. The color control method of claim 4, wherein the information formed by the step of forming information is to display the display colors of at least two of the plurality of display sections in a xy chromaticity diagram, a UCS chromaticity diagram, or a a*b* coordinate plane of a L*a*b* color specification system.

6. The color control method of claim 4, wherein the display colors include a white color, and the information formed by the step of forming information is to display the display colors of at least two of the plurality of display sections with a color temperatures of a white color point obtained based on the measured values of the white color.
